(19) United States
(12) Patent Application Publication
(10) Pub. No.: US 2014/0319826 A1
(43) Pub. Date: Oct. 30, 2014

(54) COUPLING FOR RANGE OF PIPE DIAMETERS

(71) Applicant: Avi Chiproot, Kfar-Saba (IL)

(72) Inventor: Avi Chiproot, Kfar-Saba (IL)

(21) Appl. No.: 13/870,200

(22) Filed: Apr. 25, 2013

(51) Int. Cl. F16L 21/06

(52) U.S. Cl. CPC F16L 21/065
USPC 285/337

(57) ABSTRACT

A pipe coupling includes an annular clamp housing that has ends which are provided with two opposing clamp members. One or more tightening elements tighten the clamp members towards each other in a direction transverse to an axial length of the annular clamp housing so as to apply a radially-inward clamping force on a pipe being clamped in the annular clamp housing. An annular seal is mounted in a tightening chamber with borders defined by inner walls of the annular clamp housing and an inner abutment. The tightening chamber has a single annular opening that faces radially inwards. Upon sufficient tightening of the one or more tightening elements, the annular seal cannot expand against the borders of the tightening chamber and can only expand radially inwards through the single annular opening.

### FIELD OF THE INVENTION

The present invention relates generally to couplings (or clamps) and grip rings for pipes, and particularly to a seal assembly for a coupling wherein tightening the seal assembly causes the seal to expand in a manner suitable for sealing different diameter pipes.

### BACKGROUND OF THE INVENTION

Many kinds of removable band-type couplings for pipes exist in the art. It is noted that throughout the specification and claims, the term “pipe” encompasses any kind of generally cylindrical object.

Such couplings have an elastomeric seal assembly which is tightened to form a watertight seal against the pipe. Couplings are known that can be used for a range of pipe diameters. Generally, such seal assemblies have two layers of gaskets (seals), for example, constructed of a first ring seal seated over a second ring seal. The seals can be easily disconnected from one another to allow sealing against different diameter pipes. For smaller diameter pipes, both the first and second ring seals are used; for larger diameters, only one seal is used.

### SUMMARY OF THE INVENTION

The present invention seeks to provide an improved seal assembly, as is described more in detail hereinbelow. Unlike the prior art, the seal assembly of the present invention is constrained to be tightened in a tightening chamber such that the seal can be sealingly tightened against a relatively large diameter pipe, and increased tightening of the seal assembly causes the seal to expand radially inwards towards an outer circumference of the pipe so that the seal can be sealingly tightened against a relatively small diameter pipe, thereby compensating the difference in diameters of the pipes with a single sealing ring.

There is thus provided in accordance with an embodiment of the present invention a pipe coupling including an annular clamp housing that has ends which are provided with two opposing clamp members and that includes one or more tightening elements for tightening the clamp members towards each other in a direction transverse to an axial length of the annular clamp housing so as to apply a radially-inward clamping force on a pipe being clamped in the annular clamp housing, and an annular seal mounted in a tightening chamber with borders defined by inner walls of the annular clamp housing and an inner abutment, the tightening chamber having a single annular opening that faces radially inwards, wherein upon sufficient tightening of the one or more tightening elements, the annular seal cannot expand against the borders of the tightening chamber and can only expand radially inwards through the single annular opening.

In accordance with an embodiment of the present invention the annular seal is made of a material whose volume remains substantially unchanged during tightening of the annular seal.

In accordance with an embodiment of the present invention the annular seal is constructed with an outer portion folded over an inner portion so as to define at least one inner annular space between and bounded by the inner and outer portions.

In accordance with an embodiment of the present invention the inner abutment is substantially perpendicular to a circumference of a pipe inserted in the clamp.

In accordance with an embodiment of the present invention the inner abutment is not perpendicular to a circumference of a pipe inserted in the clamp.

In accordance with an embodiment of the present invention the inner abutment is slanted so that a radially inward area of the tightening chamber is smaller than a radially outward area of the tightening chamber.

### BRIEF DESCRIPTION OF THE DRAWINGS

The present invention will be understood and appreciated more fully from the following detailed description, taken in conjunction with the drawing in which:

FIG. 1 is a simplified pictorial illustration of a pipe coupling with a seal assembly, constructed and operative in accordance with a non-limiting embodiment of the present invention;

FIG. 2 is a simplified sectional illustration of a seal assembly including a straight-wall tightening chamber for the seal, and in which the seal has an inner annular space for hydraulically increasing tightening of the seal, in accordance with an embodiment of the present invention;

FIG. 3 is a simplified sectional illustration of a seal assembly including a straight-wall tightening chamber for the seal, with no hydraulic inner annular space, in accordance with an embodiment of the present invention;

FIG. 4 is a simplified sectional illustration of a seal assembly including a tapered-wall tightening chamber for the seal, and in which the seal has an inner annular space for hydraulically increasing tightening of the seal, in accordance with an embodiment of the present invention; and

FIG. 5 is a simplified sectional illustration of a seal assembly including a tapered-wall tightening chamber for the seal, with no hydraulic inner annular space, in accordance with an embodiment of the present invention.

### DETAILED DESCRIPTION OF EMBODIMENTS

Reference is now made to FIG. 1, which illustrates a pipe coupling 10 with a seal assembly 20, constructed and operative in accordance with a non-limiting embodiment of the present invention.

Pipe coupling 10 includes an annular clamp housing 12, typically made of a flexible metal sheet, such as but not limited to, stainless steel. Annular clamp housing 12 is adapted for sealing against pipes of different diameters, such as a relatively large diameter pipe 14 and a relatively small diameter pipe 16. The ends of annular clamp housing 12 are provided with two opposing clamp members 18. One or more tightening elements 19 (e.g., one or more mechanical fasteners, such as a bolt or screw and a tightening nut, and possibly washer) fasten and tighten clamp members 18 towards each other in a direction transverse to the axial length of annular clamp housing 12 so as to apply a radially-inward clamping force on the pipe being clamped.

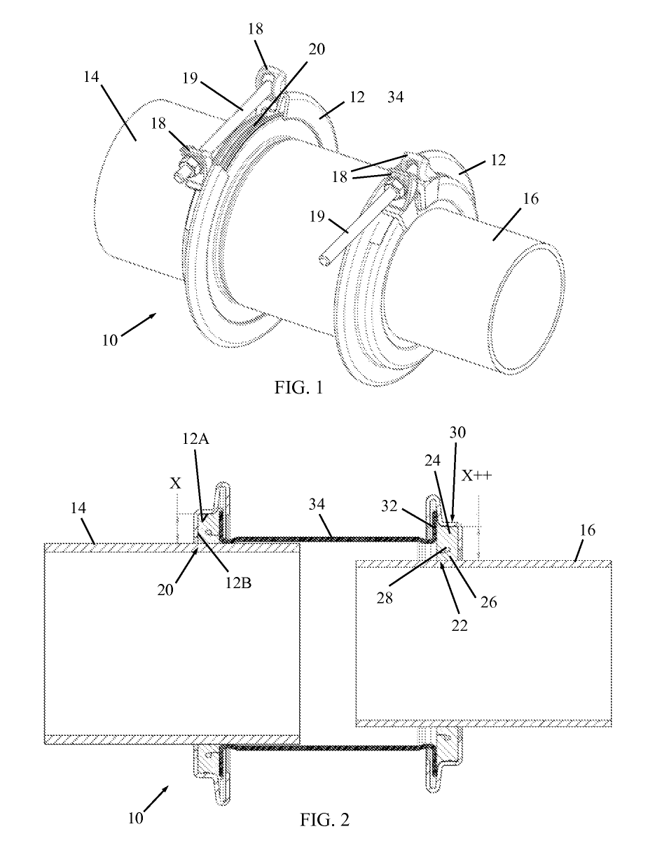

The annular seal assembly 20 can be provided in different configurations as is now described. The first exemplary embodiment is described with reference to FIG. 2.

In this embodiment, annular seal assembly 20 includes an annular seal 22. All the seals of the present invention, without limitation, may be made of a rubber (e.g., EPDM (ethylene propylene diene monomer), butyl, styrene butadiene or neoprene) or a thermoplastic elastomer (e.g., polyurethane or olefin) compatible with the fluid to be carried in the pipe. For example, without limitation, the seal may be made of EPDM rubber with 70-80 Shore A durometer.

Annular seal 22 is constructed with an outer portion 24 folded over an inner portion 26 so as to define at least one inner annular space 28 between and bounded by the inner and outer portions 26 and 24. Annular seal 22 is mounted in a tightening chamber 30 defined by inner walls of annular clamp housing 12 (which include an outer ring wall 12A and a transverse inner wall 12B) and an inner abutment 32. In the illustrated embodiment, the inner abutment 32 is the face of a cylindrical member 34 that connects or bridges between the left side clamp 10 and the right side clamp 10. However, the invention can also be carried out with just one clamp without cylindrical member 34, in which case the inner abutment 32 may be the face of an end member or flange and the like. The inner wall 12B may be planar as shown, or alternatively, may be curved or bulged.

The left side clamp is tightened against large diameter pipe 14, whereas the right side clamp is tightened against small diameter pipe 16. The difference in the amount the tightening element 19 of the clamp has been tightened for the right side clamp as opposed to the left side clamp is easily seen in FIG. 1. The additional tightening of the right side clamp applies increased force on the annular seal 22 of annular seal assembly 20. As is well known in engineering, the force required to achieve the proper seal depends mostly on three factors: the cross section of the seal, the durometer of the seal material, and the percent squeeze required. Since the seal is rubber or other suitable elastomer for this application, the volume of the elastomeric material does not change. The annular seal 22 cannot expand against the borders of the tightening chamber 30, and tightening chamber 30 has a single annular opening that faces radially inwards. Therefore, annular seal 22 has only one direction to expand and maintain a constant volume, namely, radially inwards towards the longitudinal centerline of pipe 16. Thus, the additional tightening of the right side clamp causes annular seal 22 to extrude outwards of tightening chamber 30 towards the outer circumference of pipe 16 and seal thereagainst. The difference in radial height of seal 22 between the left side clamp and the right side clamp is shown in the figure as x (left side) and x++ (right side). This is the range of pipe diameters for sealing by annular seal 22.

The inner annular space 28 is in fluid communication with a fluid (e.g., water, not shown) flowing in pipes 14 and 16. The fluid enters inner annular space 28 via one or more apertures (not shown) formed in a side wall of the seal 22. The fluid applies pressure in inner annular space 28 to increase tightening of the seal.

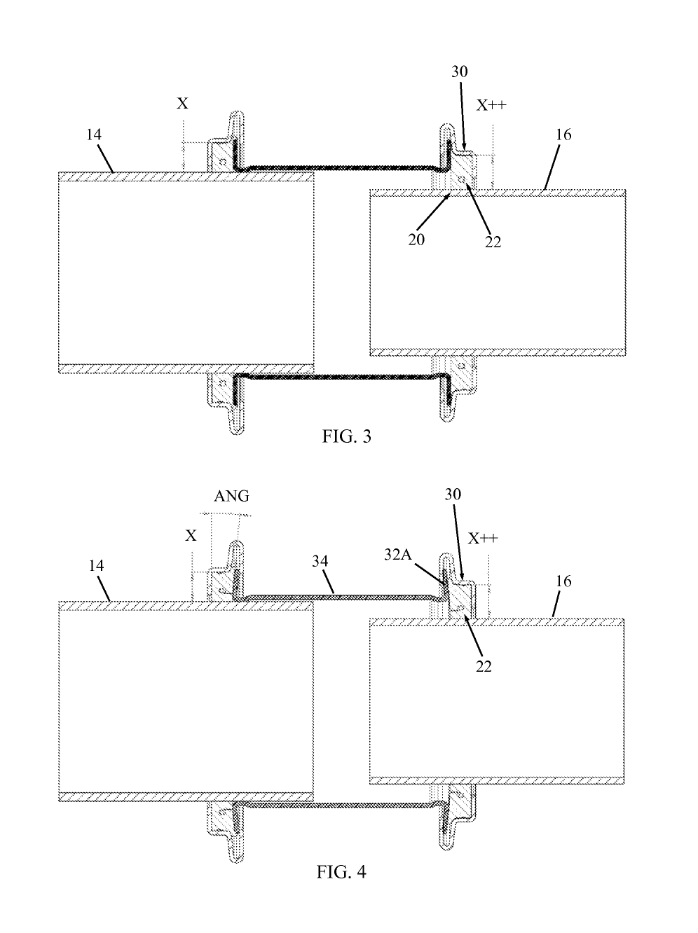

Reference is now made to FIG. 3. This embodiment is basically the same as the embodiment of FIG. 2, except there is no hydraulic inner annular space.

Reference is now made to FIG. 4. This embodiment is basically the same as the embodiment of FIG. 2, except there is an inner abutment 32A which is tapered, that is, not perpendicular to the circumference of the pipe. In particular, inner abutment 32A is slanted (at an angle “Ang” from the vertical) so that the radially inward area of tightening chamber 30 is smaller than the radially outward area of tightening chamber 30. This means the area from which seal 22 extrudes out of the tightening chamber 30 towards the outer circumference of pipe 16 is smaller than that of the embodiment of FIG. 2. Thus, the embodiment of FIG. 4 further constrains the possible opening for the seal to expand and further increases the range of pipe diameters for sealing.

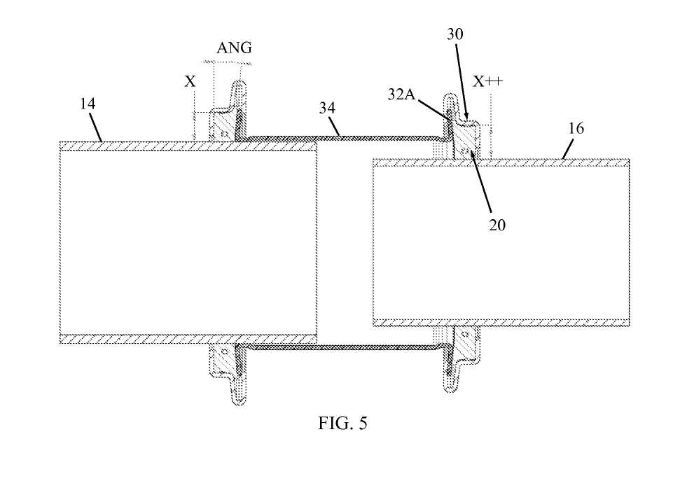

Reference is now made to FIG. 5. This embodiment is basically the same as the embodiment of FIG. 4, except there is no hydraulic inner annular space.

The scope of the present invention includes both combinations and subcombinations of the features described hereinabove as well as modifications and variations thereof which would occur to a person of skill in the art upon reading the foregoing description and which are not in the prior art.

What is claimed is:

1. A pipe coupling comprising:
an annular clamp housing that has ends which are provided with two opposing clamp members and that comprises one or more tightening elements for tightening said clamp members towards each other in a direction transverse to an axial length of said annular clamp housing so as to apply a radially-inward clamping force on a pipe being clamped in said annular clamp housing; and
an annular seal mounted in a tightening chamber with borders defined by inner walls of said annular clamp housing and an inner abutment, said tightening chamber having a single annular opening that faces radially inwards, wherein upon sufficient tightening of said one or more tightening elements, said annular seal cannot expand against the borders of said tightening chamber and can only expand radially inwards through the single annular opening.

2. The pipe coupling according to claim 1, wherein said annular seal is made of a material whose volume remains substantially unchanged during tightening of said annular seal.

3. The pipe coupling according to claim 1, wherein said annular seal is constructed with an outer portion folded over an inner portion so as to define at least one inner annular space between and bounded by said inner and outer portions.

4. The pipe coupling according to claim 1, wherein said inner abutment is substantially perpendicular to a circumference of a pipe inserted in said clamp.

5. The pipe coupling according to claim 1, wherein said inner abutment is not perpendicular to a circumference of a pipe inserted in said clamp.

6. The pipe coupling according to claim 5, wherein said inner abutment is slanted so that a radially inward area of said tightening chamber is smaller than a radially outward area of said tightening chamber.
